(19) United States
(12) Patent Application Publication
(10) Pub. No.: US 2014/0373879 A1
(43) Pub. Date: Dec. 25, 2014

(54) DEVICE AND METHOD FOR CLEANING EMISSION PROTECTION INSTALLATIONS IN COKE QUENCHING TOWERS

(71) Applicants: Thorsten Conrad, Essen (DE); Bodo Freimuth, Oberhausen (DE); Klaus Freimuth, Oberhausen (DE)

(72) Inventors: Thorsten Conrad, Essen (DE); Bodo Freimuth, Oberhausen (DE); Klaus Freimuth, Oberhausen (DE)

(73) Assignee: THYSSENKRUPP INDUSTRIAL SOLUTIONS AG, Essen (DE)

(21) Appl. No.: 14/351,512

(22) PCT Filed: Aug. 15, 2012
(86) PCT No.: PCT/EP2012/065961

§ 371 Date: Jun. 6, 2014

(30) Foreign Application Priority Data
Oct. 14, 2011 (DE) 10 2011 054 515.8

(51) Int. Cl. C10B 43/08; B08B 3/02

(52) U.S. Cl. CPC C10B 43/08; B08B 3/024
USPC 134/34; 134/172

(57) ABSTRACT

A device and a method for cleaning emission protection installations in coke quenching towers. The emission protection installations are fixed to a support structure in the chimney of the coke quenching tower. A liquid is sprayed onto the emission protection installations by nozzles for cleaning purposes. The nozzles are arranged on at least one movable element.

The invention relates to an apparatus and a method for cleaning emission protection installations which are fastened to a support structure in the chimney of a coke quenching tower, wherein a liquid is sprayed onto the emission protection installations by means of nozzles.

Emission protection installations for separating particles from the quenching vapor are installed in the chimney of coke quenching towers for the wet quenching of glowing coke. The emission protection installations commonly comprise lamellae, at which solid particles are separated. The lamellae consist of a plastic or a metal. Metal lamellae preferably consist of high-grade steel. The emission protection installations cover the entire cross section of the chimney. They are fastened to a support structure preferably configured like a pitched roof or monopitch roof.

The particles are deposited on the surfaces of the lamellae and lead over time to blockages. The increase in weight owing to the particle deposits can moreover lead to static overloading. Therefore, the emission protection installations are rinsed from time to time. To this end, a liquid is sprayed onto the lamellae by means of nozzles. In this context, a spraying operation is understood to mean any type of application of a liquid which is suitable for rinsing the particles from the lamellae. The time intervals after which a cleaning cycle is carried out can vary, from after each quenched fire up to after every eighth quenched fire. The degree of deposits on the lamellae is the deciding factor.

A pump provides the volumetric flow rate of liquid which is needed for the flushing operation at the pressure required therefor. Each nozzle has only a limited region of action. In order to clean all of the lamellae distributed over the entire cross section of the chimney, a large number of nozzles are required. In conventional installations, use is made, for example, of two times seven rows with a total of 50 nozzles. Each of the nozzles has a throughput of approximately 9 liters of water per minute at an inlet pressure of 3 bar. In order to supply all of the nozzles with water at the same time, a high volumetric flow rate is required, and this can be provided only by powerful and expensive pumps or by the use of a plurality of pumps.

It is an object of the invention to provide an apparatus and a method having the features described in the introduction, in the case of which the required volumetric flow rate of liquid is reduced and nevertheless intensive and reliable cleaning of the emission protection installations is ensured.

This object is achieved according to the invention in that the nozzles are arranged on at least one movable element. The element, together with the nozzles arranged thereon, moves along the cross section of the chimney during the cleaning operation, and therefore each nozzle, in contrast to conventional methods, cleans a larger number of lamellae. Considerably fewer nozzles are required for the cleaning in the method according to the invention. Since fewer nozzles have to be supplied with water per unit of time, it is possible to use smaller and therefore less expensive pumps. Since a very low number of nozzles are required in the apparatus according to the invention, the procurement costs thereof are reduced, as are the maintenance costs for eliminating blockages of individual nozzles.

The support structure to which the emission protection installations are fastened is preferably configured like a pitched roof or monopitch roof. In the variant of a pitched roof, the structure comprises a top edge, which is referred to as a crown, two bottom edges, which are referred to as the eave, and also four side edges. The monopitch roof structure comprises two side edges in addition to a crown and an eave.

The movable element with the nozzles is arranged such that it can move above the emission protection installations. In this respect, the nozzles are preferably positioned in rows, which extend above the support structure between the crown and the eave. The rows of nozzles can be displaced parallel to the side edges by means of the movable element. In the case of a monopitch roof, at least one row is required for this purpose. In the case of a pitched roof, at least one row is required on each side of the support structure. It proves to be particularly expedient if two rows are arranged in parallel alongside one another on each side and are displaced by means of the movable element during a cleaning operation.

In principle, it is also possible for each nozzle to be supplied individually with water. However, it proves to be advantageous if a plurality of nozzles are arranged along a duct, through which water is supplied. For this purpose, use is preferably made of ducts made of plastic, since these are particularly lightweight. The ducts are fastened to the movable element and preferably run in a direction between the crown and the eave. During the cleaning operation, the ducts are displaced parallel to the side edges of the support structure.

In a very simple variant of the invention, boreholes which serve as nozzles can be made in the duct. In preferred variants, use is made of dedicated nozzle elements which are positioned along the duct and are supplied with water thereby. The use of fan nozzles proves to be particularly expedient.

The nozzles are arranged along the duct preferably with different spray ejection angles in relation to one another, in order to reach both lamellae in the top region of the support structure and lamellae in the bottom region of the support structure.

The movable element comprises at least two supporting components which are connected by at least one traversing component. By way of example, the supporting components can be trolleys, the rollers of which move on linear tracks. Alternatively, the supporting components can also have runners for displacing the movable element. The traversing component of the movable element can also be supported directly on the linear track by rollers or sliding surfaces. In this case, the rollers or sliding surfaces form the supporting components.

The movable element is preferably displaced by means of the rollers or sliding rails along a linear track running parallel to the crown and a second linear track running parallel to an eave. Rails or a smooth surface can serve as the linear track.

The nozzles are arranged on the traversing component of the movable element. A beam or a frame can be used, for example, as the traversing component. In the case of a monopitch roof, the traversing component towers above the entire support structure. In the case of a pitched roof, each side of the support structure is surmounted by a traversing component.

In order to achieve a further reduction in the quantity of water required per unit of time, in a particularly advantageous embodiment of the invention, the nozzles are actuated during the movement operation in such a manner that only ever some of the nozzles spray water. For this purpose, the nozzles are divided into groups. Each group comprises a fixed number of nozzles, these being actuated in phases by means of a control device such that a first group of nozzles sprays liquid during a first phase and another group sprays liquid during a second phase.

A row of nozzles can be displaced repeatedly back and forth from one side edge to the opposite side edge along a linear guide line during a cleaning cycle. The cleaning cycle is divided into a plurality of phases, during which different groups of nozzles are actuated for spraying. A cleaning cycle is ended when all groups have run through a spraying phase.

Further features and advantages of the invention become apparent from the description of an exemplary embodiment on the basis of drawings and from the drawings themselves. In the drawings:

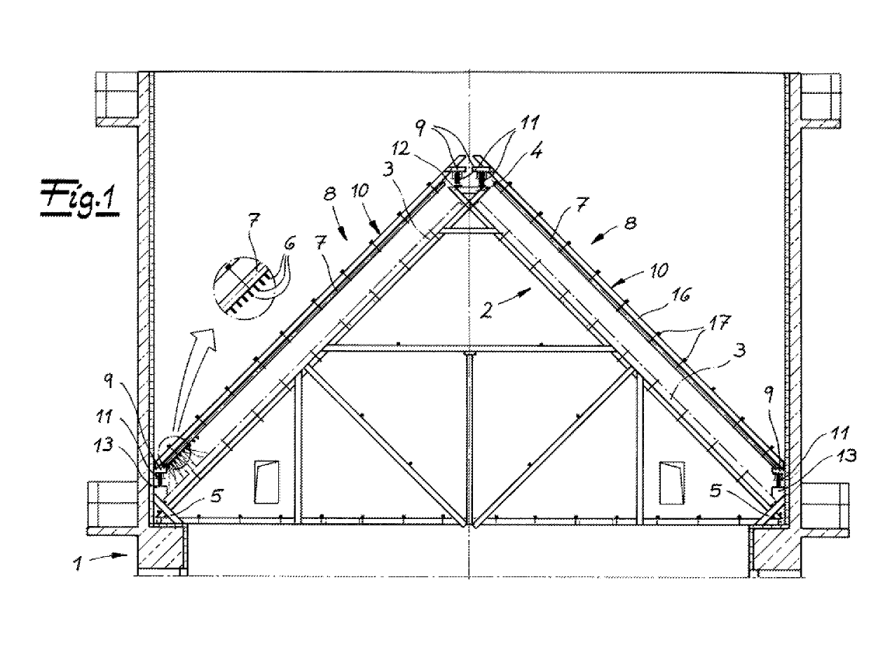

FIG. 1 shows a side view of the support structure with emission protection installations and cleaning apparatus,

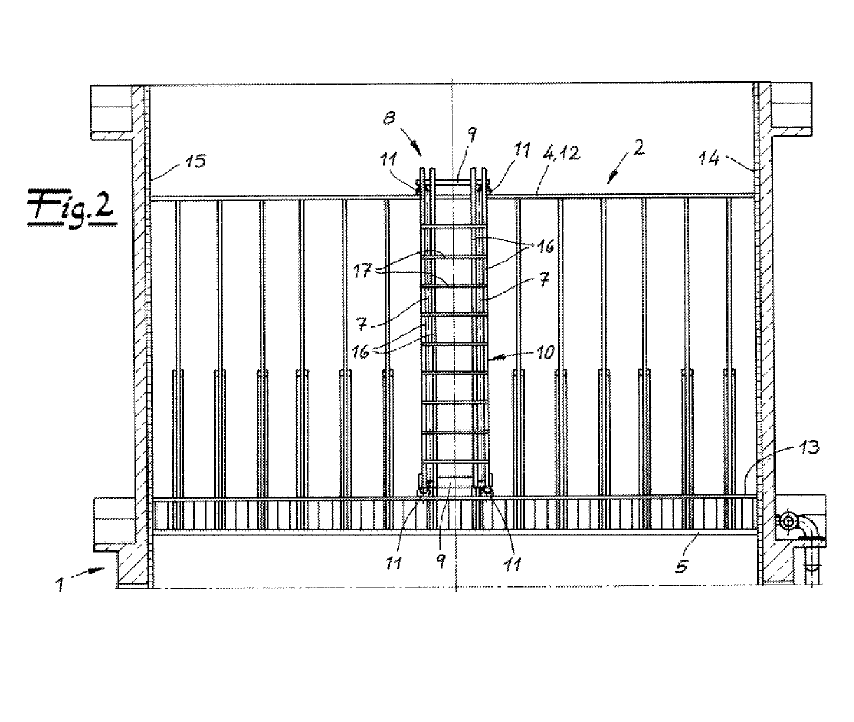

FIG. 2 shows a side view turned through 90° with respect to FIG. 1.

FIG. 1 shows a chimney 1 of a coke quenching tower. Emission protection installations 3 are fastened to a support structure 2. In the exemplary embodiment, this is a support structure 2 in the form of a pitched roof, which has a crown 4 and an eave 5 on each of the two sides of the support structure 2. At the lamellae of the emission protection installations 3, solid particles are separated from the quenching vapor which ascends from the chimney 1 upon wet quenching of the coke.

Nozzles 6 are arranged above the support structure 2 and spray water onto the lamellae for cleaning the emission protection installations 3. By way of example, fan nozzles can be used as nozzles 6. A detailed illustration on an enlarged scale shows that the nozzles 6 are arranged in a row on ducts 7. The ducts 7 consist of plastic and supply the nozzles 6 with water.

Each nozzle sprays 5 to 15 liters of water per minute at an inlet pressure of 1.5 to 4 bar. Preference is given to a water throughput per nozzle of approximately 9 l/min at an inlet pressure of approximately 3 bar. The water is provided in the quantity required for the flushing operation and at the required pressure by way of a pump.

FIG. 2 shows that, in the exemplary embodiment, in each case two ducts 7 are fastened to each movable element 8, these each traversing a side of the support structure 2 in the form of a pitched roof from the crown 4 as far as an eave 5. Each movable element 8 comprises two supporting components 9 connected by a traversing component 10. In the exemplary embodiment, trolleys serve as the supporting components 9. Each trolley has rollers 11 which move along linear tracks 12, 13 upon displacement of the element 8. The top trolley moves on a top linear track 12, which runs parallel to the crown 4. The bottom trolley moves on a bottom linear track 13, which runs parallel to an eave 5. The linear tracks 12, 13 can be formed as rails or as sliding surfaces.

In the exemplary embodiment, the traversing component 10 of the movable element 8 is formed by a frame which comprises longitudinal beams 16 extending above the support structure 2 from the crown 4 to an eave 5. The longitudinal beams 16 are connected by a plurality of crossbeams 17. In each case two ducts 7 are fastened to each traversing component 10 and flush the emission protection installations 3 free of the dirt deposits by means of the nozzles 6 thereof.

Each movable element 8 is driven by a motor. In the simplified illustrations shown in FIGS. 1 and 2, the motors are not shown. The motor can be positioned fixedly at a location outside the movable element 8. By way of example, the motor can be arranged in a stationary manner on the support structure 2. In this variant, a connection is made to the movable element 8 by way of chains or cables, for example. Alternatively, the motor can be arranged on the movable element 8 itself, such that it concomitantly moves when the latter is moved, in which case the drive can be performed by way of toothed wheels which mesh with toothed rods or immovably clamped chains, toothed belts or the like.

In FIG. 1, it has been indicated that, as the movable element 8 is being displaced, only some of the nozzles 6 spray water onto the emission protection installations 3. The exemplary embodiment shows a phase of the cleaning process in which only one group of nozzles 6 in the bottom region of a nozzle row sprays water onto the emission protection installations 3. During a cleaning cycle, the rows of nozzles 6 repeatedly pass over a complete side of the support structure 2. The period of time required to displace the movable element 8 from a side edge 14 to the opposite side edge 15 of the support structure is referred to as a phase. During each phase, a different group of nozzles 6 is activated for spraying. The cleaning cycle is ended when all groups of nozzles 6 have run through a phase.

1. An apparatus for cleaning emission protection installations which are fastened to a support structure in the chimney of a coke quenching tower, wherein a liquid can be sprayed onto the emission protection installations by means of nozzles, wherein the nozzles are arranged on at least one movable element.

2. The apparatus as claimed in claim 1, wherein the nozzles are arranged in at least one row, wherein the row can be displaced along at least part of the cross section of the chimney opening by means of the movable element.

3. The apparatus as claimed in claim 1, wherein the nozzles are arranged along a duct.

4. The apparatus as claimed in claim 1, wherein the movable element has at least two supporting components and at least one traversing component.

5. The apparatus as claimed in claim 1, wherein the movable element can be displaced along at least one linear track.

6. The apparatus as claimed in claim 1, wherein the nozzles are connected to a control device, which is set up to actuate groups of nozzles in phases during a cleaning cycle.

7. A method for cleaning emission protection installations which are fastened to a support structure in the chimney of a coke quenching tower, wherein a liquid is sprayed onto the emission protection installations by means of nozzles, wherein the nozzles are moved during the spraying operation.

8. The method as claimed in claim 7, wherein at least one row of nozzles is displaced along at least part of the cross section of the chimney opening during the spraying operation.

9. The method as claimed in claim 8, wherein rows of nozzles are displaced above the support structure parallel to the side edges thereof.

10. The method as claimed in claim 7, wherein a cleaning cycle comprises a plurality of phases, during which different groups of nozzles spray liquid.

11. The method as claimed in claim 7, wherein the nozzles are displaced repeatedly back and forth from one side edge to the opposite side edge of the support structure during a cleaning cycle.
